(19) United States
(12) Patent Application Publication
(10) Pub. No.: US 2003/0110836 A1
(43) Pub. Date: Jun. 19, 2003

(54) Method and system for evaporative leak detection for a vehicle fuel system

(76) Inventor: Joon-Kwan Cho, Suwon-city (KR)

Correspondence Address: Pennie & Edmonds, LLP, 3300 Hillview Avenue, Palo Alto, CA, 94304, US

(21) Appl. No.: 10/321,068

(22) Filed: Dec. 16, 2002

(30) Foreign Application Priority Data
Dec. 18, 2001 (KR) 2001-0080512

(51) Int. Cl. G01M 3/04

(52) U.S. Cl. 73/40.7

(57) ABSTRACT

A vapor leak detection method and system is provided. The detection method comprises: sealing an ullage; purging fuel vapors of the sealed ullage into an air intake system for a predetermined period so that a negative pressure is formed in the ullage; and determining if the ullage has a leak, based on changes of the negative pressure in the ullage. The system includes a pressure sensor for detecting pressure in the ullage of a fuel tank; a canister that collects volatile fuel vapors from the ullage that were generated by the vaporization of liquid fuel; a purge control solenoid valve for directing fuel vapors into an air intake system; a canister close valve for selectively venting the ullage to atmosphere; and an engine control unit implementing the method.

### FIELD OF THE INVENTION

The present invention generally relates to an automotive fuel storage system, and more particularly, to a system and method for detecting fuel vapor leakage from the ullage of an automotive fuel system.

### BACKGROUND OF THE INVENTION

Generally, the noxious gases that are exhausted from a vehicle include exhaust gas, blow-by gas generated in a crankcase, and evaporated fuel gas (“EFG”) generated in a fuel supply system. EFG, in particular, can cause serious air pollution. To prevent such leaks, leak detection is performed in a vehicle manufacturing line.

In a general automotive evaporated gas leak detection system a pressure sensor detects the pressure in the ullage of the fuel tank. Fuel in the tank vaporizes and generates fuel vapors. These are collected by a canister, which is connected to the ullage. From the canister, a purge control solenoid valve (“PCSV”) allows fuel vapors to flow into an air intake system (for example, a surge tank) and a canister close valve (“CCV”) selectively vents the ullage to atmosphere. The PCSV and the CCV are controlled by an engine control unit (“ECU”), which also performs leak detection based on pressure signals from the ullage and pressure sensor.

The technique conventionally employed by the general automotive in evaporated gas leak systems detects large leaks in the fuel tank, but it is not sufficient to determine the difference between a very small leak and no leak at all. Thus, it may not satisfy more strict emission regulations. Also, even small leaks of EFG are detrimental to the environment considering the numbers of automobiles produced. It is, therefore, desirable to have a leak detection method and system capable of detecting leaks of all sizes.

### SUMMARY OF THE INVENTION

In a preferred embodiment of the present invention, the evaporative emission leak detection method comprises: sealing an ullage; venting fuel vapors from the sealed ullage into an air intake system for a predetermined period after the sealing so that a negative pressure develops in said ullage; and determining if the ullage has a leak, based on changes of the negative pressure in said ullage.

Preferably, the determining comprises concluding that the ullage has a large leak if a pressure in the ullage at the point after a predetermined period from the venting is not less than a predetermined pressure.

In another preferred embodiment of the present invention, the determining comprises: detecting the lowest pressure in the ullage after said sealing; calculating a first pressure difference between the lowest pressure and a pressure detected a predetermined period after detecting the lowest pressure, and a second pressure difference detected between said sealing and said venting; calculating a third pressure difference between the first pressure difference and the second pressure difference; and determining if the third pressure difference is larger than a predetermined value.

It is preferable that the method of the present invention further comprises determining that the ullage has a small leak if it is determined that the third pressure difference is larger than the predetermined value.

In an alternative embodiment of the present, the evaporative emission leak detection system for a fuel system of a vehicle engine comprises: a canister, a purge control solenoid valve, a pressure sensor, and an electronic control unit. The canister collects fuel vapors generated in the ullage. The purge control solenoid valve vents fuel vapors collected by the canister into an air intake system. A canister close valve is disposed in a passageway connecting the canister to the atmosphere, and it selectively opens and closes the passageway. The pressure sensor detects a pressure in the ullage and outputs a corresponding signal. The control unit controls operations of the purge control solenoid valve and the canister close valve, and performs leak detection based on the signals input from the pressure sensor. More preferably, the control unit is programmed to execute steps comprising: operating the canister close valve to seal the ullage; operating the purge control valve for a predetermined time so that fuel vapors in the ullage are vented to the air intake system for a predetermined period from the operation of the canister close valve; determining if a pressure in the ullage at the point after a predetermined period from the operation of the purge control solenoid valve is not less than a predetermined pressure, and if so, determining that the ullage has a large leak; detecting the lowest pressure in said ullage, if it is determined that the pressure in said ullage at the point after the predetermined period from the operation of the purge control solenoid valve is not less than the predetermined pressure; calculating a pressure difference between a first pressure difference, which is a difference between a pressure at a point after a predetermined period from the point when the lowest pressure is detected and the lowest pressure, and a second pressure difference, which is a difference between a pressure at the start point of the operation of the purge control solenoid valve and a pressure at the start point of the operation of the canister close valve; and determining if the calculated pressure difference is larger than a predetermined value.

### BRIEF DESCRIPTION OF THE DRAWINGS

The following detailed description of the preferred embodiments of the invention will be more fully understood with reference to the following figures, in which:

FIG. 1 is a block diagram of a general leak detection system;

FIG. 2 shows pressure changes and the operation of the CCV and PCSV of the leak detection method according to a preferred embodiment of the present invention; and

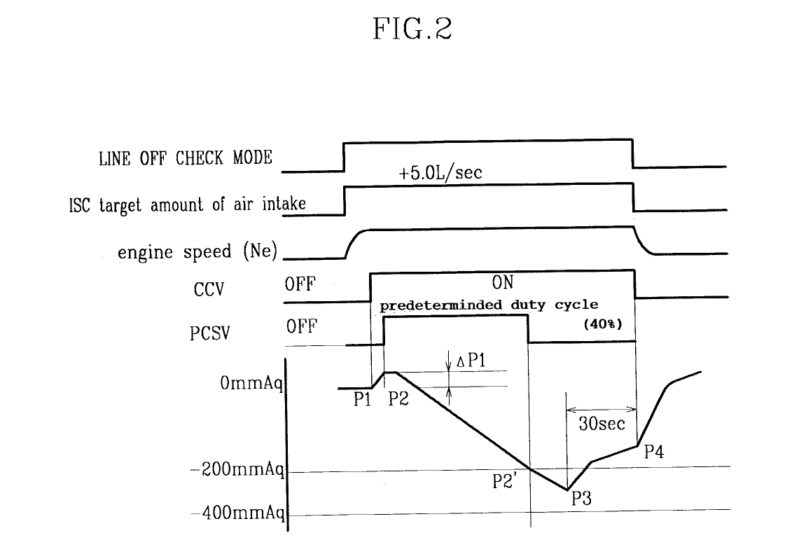

FIG. 3 is a flowchart of a preferred embodiment of the leak detection method of the present invention.

Like numerals refer to similar elements throughout the several drawings.

### DETAILED DESCRIPTION OF THE PREFERRED EMBODIMENTS

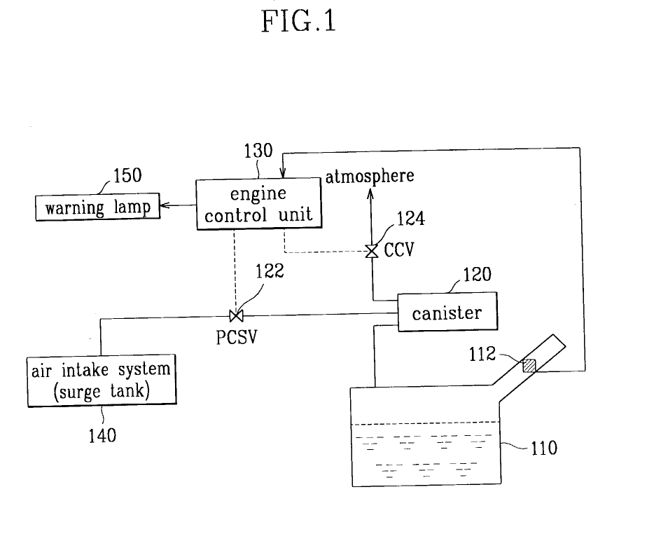

As shown in FIG. 1, in an automotive evaporated gas leak detection system a pressure sensor 112 detects pressure in the ullage of a fuel tank 110. A canister 120 collects volatile fuel vapors from the ullage that were generated by the vaporization of liquid fuel. A purge control solenoid valve (“PCSV”) 122 allows fuel vapors to flow into an air intake system (for example, a surge tank) 140. The air intake system could be that of the automobile, or a separate system that creates a reduced pressure causing fuel vapors to flow from the ullage. A canister close valve (“CCV”) 124 vents the ullage to atmosphere. An engine control unit (“ECU”) 130 controls the operation of the PCSV and the CCV, and performs the leak detection based on pressure signals from the ullage and pressure sensor 112 as described in greater detail below. The ullage is defined primarily by the fuel tank headspace and the canister 120, and is often known as the evaporative emission space.

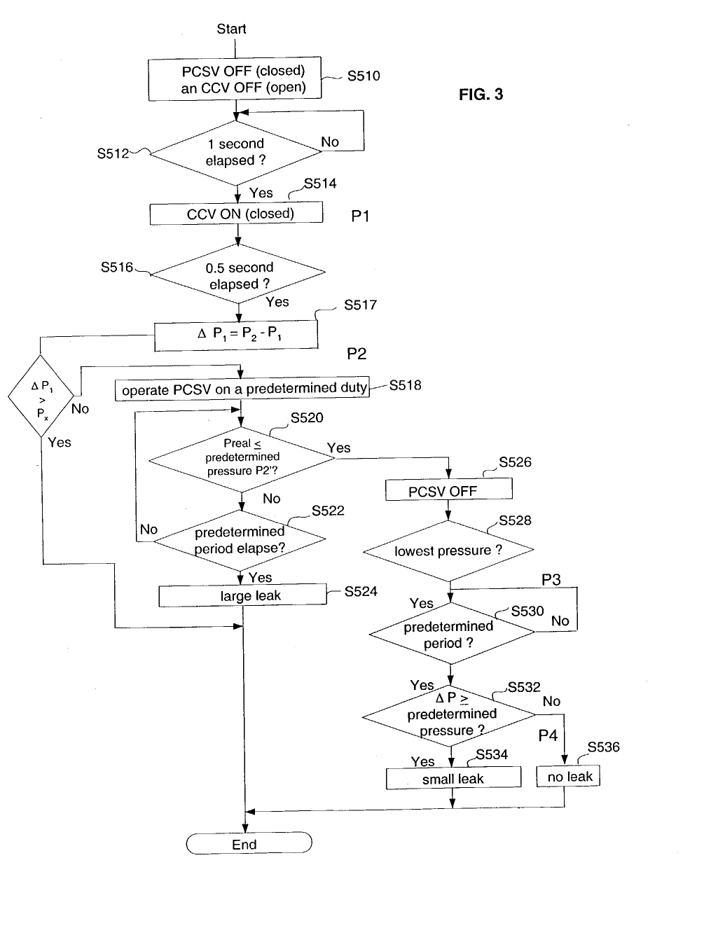

In a general evaporative leak detection method, described using the system of FIG. 1, making reference to the pressures and timing of FIG. 3, and with reference to part of FIG. 3, in step S510, if monitoring conditions for evaporative leak detection exist, the engine control unit 130 directs the PCSV 122 and the CCV 124 OFF, i.e., it closes the PCSV 122 and opens the CCV 124. These monitoring conditions are: the ECU 130 receives a leakage check mode code from a multi-use tester (this tester is provided in the vehicle manufacturing line); the transmission shift lever is in neutral; and the vehicle is stationary (specifically, the vehicle speed is less than 1.25 km/h). If one of the conditions does not exist, the leak detection will be stopped.

After a first predetermined period (preferably one second) elapses after step S512, the ECU 130 closes the CCV 124 so the ullage is sealed at step S514. Also, the ECU 130 stores a signal indicative of the pressure P1 in the ullage at the point when the CCV 124 is turned ON (closed). At step S516, a second predetermined period (0.5 second) elapses from the point when the CCV 124 is closed. At step S517, the ECU 130 stores a signal indicative of the pressure in the ullage (P2) and calculates the pressure difference ΔP1 using the equation ΔP1=P2−P1. If ΔP1, which is caused by the fuel evaporation, is greater than a predetermined value Px, the ECU 130 discontinues the monitoring because leak detection may be inaccurate if the pressure increase caused by the evaporation of fuel is too high (above Px). The value Px is determined so that the monitoring is performed when the pressure in the fuel tank is stable. Preferably the leak detection is also stopped when the intake air temperature is lower than a predetermined level.

In step S518, the ECU 130 operates the PCSV 122 at a predetermined duty cycle for a predetermined period. When the PCSV 122 is open (ON) and the CCV 124 is closed (ON), the fuel vapors are allowed to be drawn into the air intake system 140 and the pressure in the ullage decreases. Operation of the PCSV 122 is then maintained for a predetermined period at the predetermined duty cycle.

Regarding the PCSV operation in step S518, the ECU 130 generates a signal for operating the PCSV 122 with a predetermined duty cycle in order to draw the fuel vapors into the air intake system 140. As an example, the predetermined duty cycle can be 40%. If the predetermined duty cycle is excessively high, the vehicle idle operation is deteriorated, and if it is excessively low, it extends the time period for performing the detection method according to the preferred embodiment of the present invention. Thus, it is preferable to set the predetermined period in step S522 in consideration of these factors. The period of the operation of the PCSV 122 is influenced by the fuel temperature sensed by fuel temperature sensor 113 and the amount of fuel in the fuel tank.

At step S520, the ECU 130 determines if a monitored pressure Preal from sensor 112 is less than a predetermined pressure (P2′) at a point during a predetermined period from the start of operation of the PCSV 122. If so, in a general leak detection system, the ECU 130 concludes that the ullage has no leaks. If not, after a predetermined period elapses at step S522, the ECU 130 concludes that the ullage has a large leak turns on a warning lamp 150 (FIG. 1).

As shown in FIG. 3, a preferred embodiment of the leak detection method of the invention generally comprises sealing the ullage; waiting for a predetermined period to elapse from the point the ullage is sealed so that the ullage develops a negative pressure; venting fuel vapors from the ullage into the air intake system; monitoring the pressure in the ullage from then onward; and performing leak detection based on the monitored pressure, where the leak detection can detect a small leak.

As used in this application a “large” leak indicates an excessive leak, such as an open fuel cap. On the other hand, a “small” leak would be an opening on the order of less than 1.0 mm. For example, the California Air Resource Board (CARB) test for a large leak is performed while the fuel cap is open, and the test for a small leak is performed while intentionally forming a leak of about 1.0 mm.

The method through step S518 follows the general method previously described, but at step S520 a preferred embodiment of the method of the invention provides the capacity to detect a small leak. As before, at step S520, the ECU 130 determines if a monitored pressure Preal from sensor 112 is less than a predetermined pressure (P2′) at a point during a predetermined period from the start of operation of the PCSV 122. Preferably, the current pressure (Preal) in the ullage is continuously read by ECU 130 from the pressure sensor 112. If the pressure is not lower than the predetermined pressure (P2′) then, in step S524, the ECU concludes that the ullage has a large leak.

In a preferred embodiment of the invention, if in step S520 it is determined within the predetermined period of step S522 that the pressure Preal is smaller than the predetermined pressure P2′, in step S526 the ECU 130 stops the operation of the PCSV 122. Then, in step S528, the ECU 130 determines the lowest pressure P3 reached in the ullage using pressure sensor 112. After a predetermined period (step S530) from the point when the lowest pressure P3 was detected in step S528, in step S532 the pressure (P4) is detected, and the pressure difference ΔP=((P4−P3)−(P2−P1)) calculated.

The value P4−P3 indicates the pressure difference caused by the fuel evaporation and the inflow of the foreign gases, with the inflow being attributed to a leak. The pressure difference ΔP1(=P2−P1) indicates a pressure difference attributable to fuel evaporation. Therefore, the pressure difference ΔP=(P4−P3)−(P2−P1) indicates a pressure difference attributable to a leak.

In step S532, if the pressure difference AP is larger than a predetermined value, the ECU concludes that the ullage has a small leak. If the pressure difference ΔP is not larger than the predetermined value of step S532, in step S536 the ECU concludes that the ullage has no leak. The predetermined value for ΔP used in step S532 is determined through experimentation.

Thus, the evaporative leak detection method according to the present invention determines not only the presence of a large leak, but also the presence of a small leak by monitoring the pressure in the ullage. Consequently, it is possible to satisfy stricter emissions regulations.

The preferred embodiments of the present invention have been described in detail above, but it should be understood that the many variations and/or modifications of the basic inventive concepts taught herein, which may appear to those of ordinary skill in the art, will still fall within the sprit and scope of the present invention, as defined in the appended claims.

What is claimed is:

1. An evaporative emission leak detection method for a vehicle fuel system, comprising:
sealing an ullage;
venting fuel vapors from the sealed ullage into an air intake system for a predetermined period after said sealing so that a negative pressure develops in said ullage; and
determining whether said ullage has a leak, based on changes of the negative pressure in the ullage.

2. The method of claim 1, wherein said determining comprises concluding that the ullage has a large leak if a pressure in the ullage at the point after a predetermined period from said venting is not less than a predetermined pressure.

3. The method of claim 1, wherein said determining comprises:
detecting the lowest pressure in the ullage after said sealing;
calculating a first pressure difference between the lowest pressure and a pressure detected a predetermined period after detecting the lowest pressure, and a second pressure difference detected during between said sealing and said venting;
calculating a third pressure difference between the first pressure difference and the second pressure difference; and
determining if the third pressure difference is larger than a predetermined value.

4. The method of claim 3, wherein said determining further comprises
determining that the ullage has a small leak if it is determined that the third pressure difference is larger than the predetermined value.

5. The method of claim 3, wherein said determining further comprises
determining that the ullage has no leak if it is determined that the third pressure difference is not larger than the predetermined value.

6. An evaporative emission leak detection system for a fuel system of a vehicle engine, comprising:
a canister for collecting fuel vapors generated in an ullage;
a purge control solenoid valve for venting fuel vapors collected by the canister into an air intake system;
a canister close valve disposed between the canister and atmosphere, said canister close valve selectively opening and closing to allow said canister to vent to said atmosphere;
a pressure sensor for detecting a pressure in the ullage and outputting a corresponding signal; and
a controller, said controller being programmed to execute steps comprising:
operating said canister close valve such that the ullage is sealed;
operating said purge control solenoid valve for a predetermined time so that fuel vapors in the ullage are allowed to be drawn into the air intake system, said operating commencing after a second predetermined period, said second predetermined period being measured from the operation of said canister close valve;
determining whether a pressure in said ullage at the point after a third predetermined period is not less than a predetermined pressure, and if so, concluding that the ullage has a large leak, said third predetermined period being measured from the beginning of the operating the purge control solenoid valve;
detecting the lowest pressure in said ullage, if it is determined that the pressure in said ullage at the point after the third predetermined period is less than the predetermined pressure;
calculating a first pressure difference between the lowest pressure and a pressure at a point a fourth predetermined period the lowest pressure was detected;
calculating a second pressure difference between the pressure at the beginning of the operating the purge control solenoid valve and the pressure at the beginning of the operating the canister close valve;
calculating a third pressure difference between said first pressure difference and said second pressure difference; and
determining whether the third pressure difference is larger than a predetermined value.

7. An evaporative emission leak detection method for a vehicle fuel system, comprising:
sealing an ullage;
venting fuel vapors from the sealed ullage into an air intake system for a predetermined period after said sealing so that a negative pressure develops in said ullage; and
determining whether said ullage has a leak, based on changes of the negative pressure in the ullage, wherein said determining comprises:
detecting the lowest pressure in the ullage after said sealing;
calculating a first pressure difference between the lowest pressure and a pressure detected a predetermined period after detecting the lowest pressure,
calculating a second pressure difference between a pressure detected at the beginning of said sealing and a pressure detected at the beginning of said venting;
calculating a third pressure difference between the first pressure difference and the second pressure difference;
determining if the third pressure difference is larger than a predetermined value; and
concluding that the ullage has a small leak if the third pressure difference is larger than the predetermined value.
